(19) United States
(12) Patent Application Publication
(10) Pub. No.: US 2010/0187946 A1
(43) Pub. Date: Jul. 29, 2010

(54) Current Diverter Ring

(76) Inventors: David C. Orlowski, Punta Gorda, FL (US); Neil F. Hoehle, Solon, IA (US); Robert A. Tejano, Aledo, IL (US); Shawn Horton, Moline, IL (US)

Correspondence Address: HAMILTON IP LAW, PC, 331 W. 3RD ST., NEWVENTURES CENTER SUITE 120, DAVENPORT, IA, 52801, US

(21) Appl. No.: 12/757,040

(22) Filed: Apr. 9, 2010

Related U.S. Application Data
(63) Continuation-in-part of application No. 12/401,331, filed on Mar. 10, 2009.
Application No. 12/401,331 is a continuation of application No. 11/378,208, filed on Mar. 17, 2006, now Pat. No. 7,521,827.
(60) Provisional application No. 61/167,928, filed on Apr. 9, 2009.
(60) Provisional application No. 61/218,912, filed on Jun. 19, 2009.
(60) Provisional application No. 60/693,548, filed on Jun. 25, 2005.

(51) Int. Cl. H01R 39/12

(52) U.S. Cl. 310/232

(57) ABSTRACT

The current diverter rings and bearing isolators serve to dissipate an electrical charge from a rotating piece of equipment to ground, such as from a motor shaft to a motor housing. The current diverter ring includes a body and a first and second wall protruding therefrom, which walls form an annular channel. The body may be affixed to a shaft, a motor housing, a bearing isolator, or other structure. In a first embodiment, a plurality of conductive segments is fixedly positioned within the annular channel to conduct electrical charges from the shaft to the motor housing. In a second embodiment, conductive segments are positioned between an inner and an outer body. The bearing isolator may incorporate an annular channel for retention of conductive segments within the stator of the bearing isolator or it may be fashioned with a receptor groove into which a current diverter ring may be mounted.

### CROSS-REFERENCE TO RELATED APPLICATIONS

The present application claims priority from provisional U.S. Pat. App. Nos. 61/167,928 filed on Apr. 9, 2009 and 61/218,912 filed on Jun. 19, 2009, and also claims priority from and is a continuation-in-part of U.S. patent application Ser. No. 12/401,331 filed on Mar. 10, 2009, which patent application was a continuation of and claimed priority from U.S. patent Ser. No. 11/378,208 filed on Mar. 17, 2006, which claimed the benefit of provisional U.S. Pat. App. No. 60/693,548 filed on Jun. 25, 2005, all of which are incorporated by reference herein in their entireties.

### FIELD OF THE INVENTION

The present invention relates to an electrical charge dissipating device, and more particularly to a current diverter ring™ for directing electrostatic charge to ground, which electrostatic charge is created through the use of rotating equipment.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### AUTHORIZATION PURSUANT TO 37 C.F.R. §1.171 (d)

A portion of the disclosure of this patent document may contain material that is subject to copyright and trademark protection. The copyright owner has no objection to the facsimile reproduction by anyone of the patent document or the patent disclosure, as it appears in the Patent and Trademark Office patent file or records, but otherwise reserves all copyrights whatsoever. CDR and Current Diverter Ring are the exclusive trademarks of Assignee, Inpro/Seal LLC.

### BACKGROUND OF THE INVENTION

Adequate maintenance of rotating equipment, particularly electric motors, is difficult to obtain because of extreme equipment duty cycles, the lessening of service factors, design, and the lack of spare rotating equipment in most processing plants. This is especially true of electric motors, machine tool spindles, wet end paper machine rolls, aluminum rolling mills, steam quench pumps, and other equipment utilizing extreme contamination affecting lubrication.

Various forms of shaft sealing devices have been utilized to try to protect the integrity of the bearing environment. These devices include rubber lip seals, clearance labyrinth seals, and attraction magnetic seals. Lip seals or other contacting shaft seals often quickly wear to a state of failure and are also known to permit excessive amounts of moisture and other contaminants to immigrate into the oil reservoir of the operating equipment even before failure has exposed the interface between the rotor and the stator to the contaminants or lubricants at the radial extremity of the seal. The problems of bearing failure and damage as applied to electrical motors using variable frequency drives (VFDs) is compounded because of the very nature of the control of electricity connected to VFD controlled motors.

VFDs regulate the speed of a motor by converting sinusoidal line alternating current (AC) voltage to direct current (DC) voltage, then back to a pulse width modulated (PWM) AC voltage of variable frequency. The switching frequency of these pulses ranges from 1 kHz up to 20 kHz and is referred to as the “carrier frequency.” The ratio of change in voltage to the change in time (ΔV/ΔT) creates what has been described as a parasitic capacitance between the motor stator and the rotor, which induces a voltage on the rotor shaft. If the voltage induced on the shaft, which is referred to as “common mode voltage” or “shaft voltage,” builds up to a sufficient level, it can discharge to ground through the bearings. Current that finds its way to ground through the motor bearings in this manner is called “bearing current.”¹ ¹http://www.greenheck.com/technical/tech_detail.php?display=files/Product_guidefa117_{—}03

There are many causes of bearing current including voltage pulse overshoot in the VFD, non-symmetry of the motor's magnetic circuit, supply unbalances, transient conditions, and others.

Any of these conditions may occur independently or simultaneously to create bearing currents from the motor shaft.² ²http://www.greenheck.com/technical/tech_detail.php?display=files/Product_guidefa117_{—}03

Shaft voltage accumulates on the rotor until it exceeds the dielectric capacity of the motor bearing lubricant, at which point the voltage discharges in a short pulse to ground through the bearing. After discharge, voltage again accumulates on the shaft and the cycle repeats itself. This random and frequent discharging has an electric discharge machining (EDM) effect, which causes pitting of the bearing's rolling elements and raceways. Initially, these discharges create a “frosted” or “sandblasted” effect on surfaces. Over time, this deterioration causes a groove pattern in the bearing race called “fluting,” which is an indication that the bearing has sustained severe damage. Eventually, the deterioration will lead to complete bearing failure.³ ³See www.Greenheck.com

The prior art teaches numerous methods of handling shaft voltages including using a shielded cable, grounding the shaft, insulated bearings, and installation of a Faraday shield. For example, see U.S. Pat. App. Pub. Nos. 2004/0233592 and 2004/0185215 filed by Oh et al., which are incorporated herein by reference. Most external applications add to costs, complexity, and exposure to external environmental factors. Insulated bearings provide an internal solution by eliminating the path to ground through the bearing for current to flow. However, installing insulated bearings does not eliminate the shaft voltage, which will continue to find the lowest impedance path to ground. Thus, insulated bearings are not effective if the impedance path is through the driven load. Therefore, the prior art does not teach an internal, low-wearing method or apparatus to efficaciously ground shaft voltage and avoid electric discharge machining of bearings leading to premature bearing failure.

### SUMMARY OF THE INVENTION

An objective of the current diverter ring is to provide an improvement to seals or bearing isolators to prevent leakage of lubricant and entry of contaminants by encompassing the stator within the rotor to create an axially directed interface at the radial extremity of the rotor. It is also an objective of the current diverter ring to disclose and claim an apparatus for rotating equipment that conducts and transmits and directs accumulated bearing current to ground.

It is another objective of the bearing isolator as disclosed and claimed herein to facilitate placement of a current diverter ring within the stator of the bearing isolator. Conductive segments may be positioned within the current diverter ring. These conductive segments may be constructed of metallic or non-metallic solids, machined or molded. Although any type of material compatible with operating conditions and metallurgy may be selected, bronze, gold, carbon, or aluminum are believed to be preferred materials because of increased conductivity, strength, corrosion and wear resistance. In another embodiment of the bearing isolator, the conductive segments may be positioned within a conductive segment annular channel formed within the stator.

It has been found that a bearing isolator having a rotor and stator manufactured from bronze has improved electrical charge dissipation qualities. The preferred bronze metallurgy is that meeting specification 932 (also referred to as 932000 or “bearing bronze”). This bronze is preferred for bearings and bearing isolators because it has excellent load capacity and antifriction qualities. This bearing bronze alloy also has good machining characteristics and resists many chemicals. It is believed that the specified bronze offers increased shaft voltage collection properties comparable to the ubiquitous lightning rod due to the relatively low electrical resistivity (85.9 ohms-cmil/ft @68 F or 14.29 microhm-cm @20 C) and high electrical conductivity (12% IACS @68 F or 0.07 MegaSiemens/cm @20 C) of the material selected.

It is another object of the current diverter ring and bearing isolator to improve the electrical charge dissipation characteristics from those displayed by shaft brushes typically mounted external of the motor housing. Previous tests of a combination bearing isolator with a concentric current diverter ring fixedly mounted within the bearing isolator have shown substantial reduction in shaft voltage and attendant electrostatic discharge machining. Direct seating between the current diverter ring and the bearing isolator improves the conduction to ground over a simple housing in combination with a conduction member as taught by the prior art. Those practiced in the arts will understand that this improvement requires the electric motor base to be grounded, as is the norm.

It is therefore an objective of the current diverter ring and bearing isolator to disclose and claim an electric motor for rotating equipment having a bearing isolator that retains lubricants, prevents contamination, and conducts and transmits bearing current to ground.

It is another objective of the current diverter ring and bearing isolator to provide a bearing isolator for rotating equipment that retains lubricants, prevents contamination and conducts electrostatic discharge (shaft voltage) to improve bearing operating life.

It is another objective of the current diverter ring to provide an effective apparatus to direct electrical charges from a shaft to a motor housing and prevent the electrical charge from passing to ground through the bearing(s).

Other objects, advantages and embodiments of the current diverter ring and bearing isolator will become apparent upon the reading the following detailed description and upon reference to drawings.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limited of its scope, the invention will be described and explained with additional specificity and detail through the use of the accompanying drawings.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limited of its scope, the invention will be described and explained with additional specificity and detail through the use of the accompanying drawings.

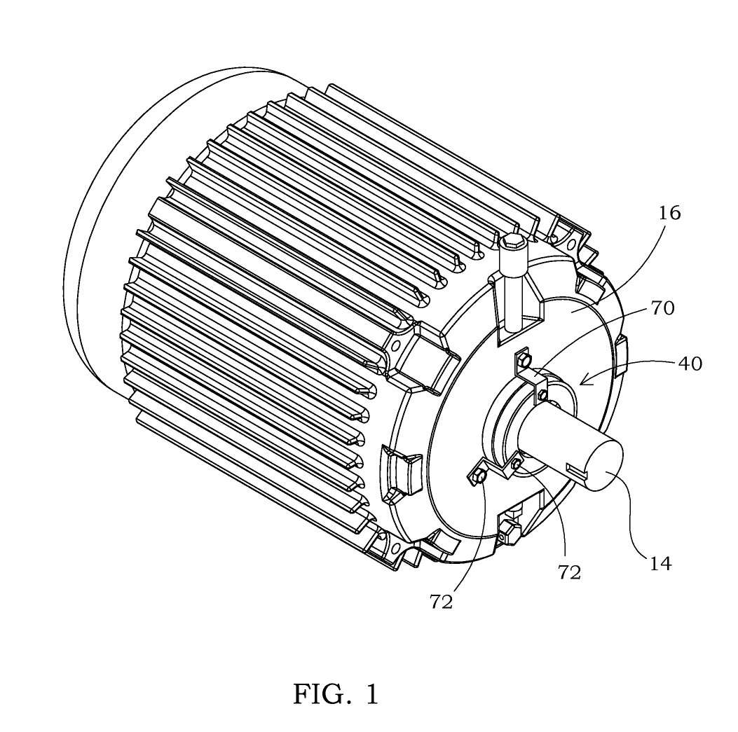

FIG. 1 is a perspective view of one embodiment of an electric motor with which the current diverter ring may be employed.

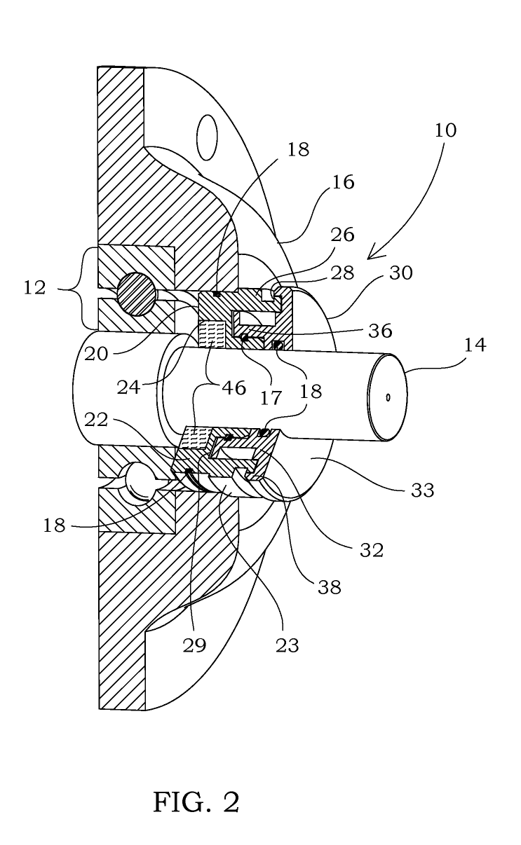

FIG. 2 is a perspective cross-sectional view of a bearing isolator wherein a portion of the stator is fashioned as a current diverter ring.

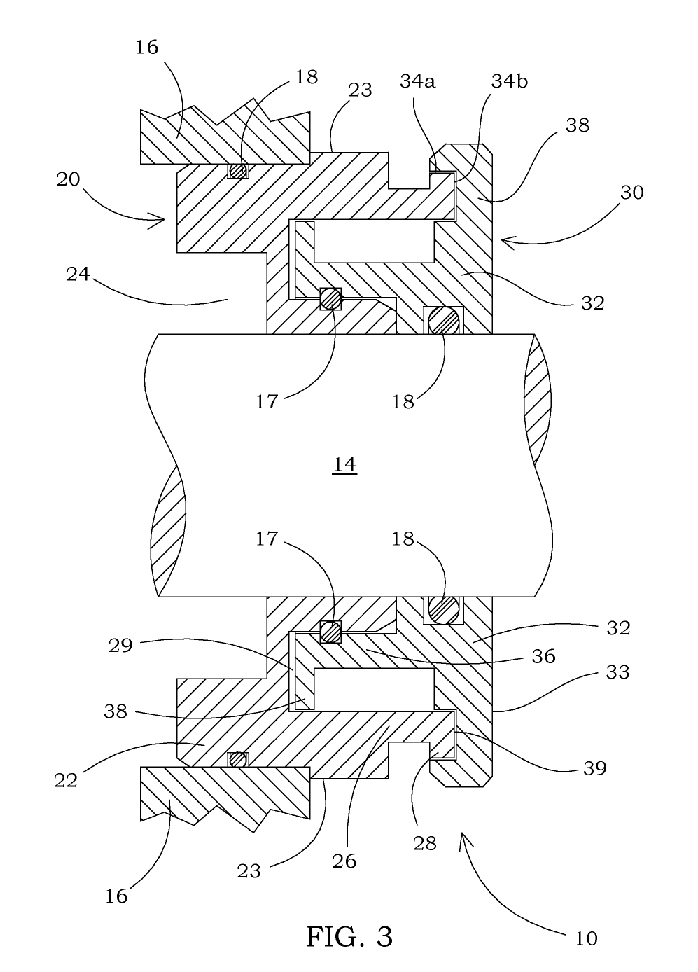

FIG. 3 is a cross-sectional view of a bearing isolator configured to accept a current diverter ring within the stator portion of the bearing isolator.

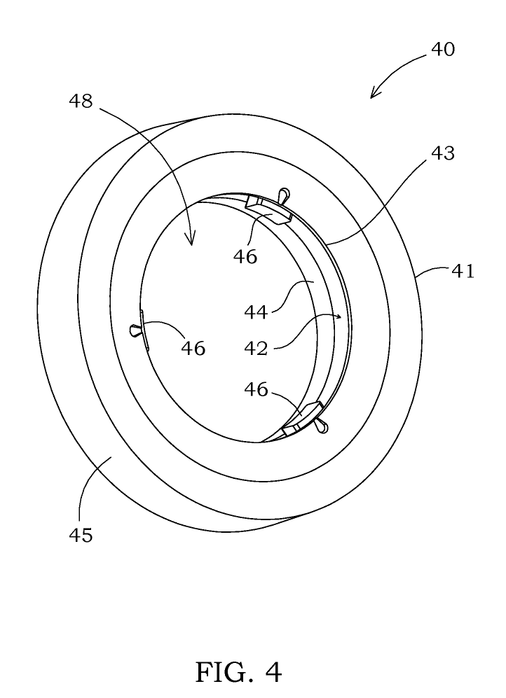

FIG. 4 is a perspective view of the first embodiment of the current diverter ring.

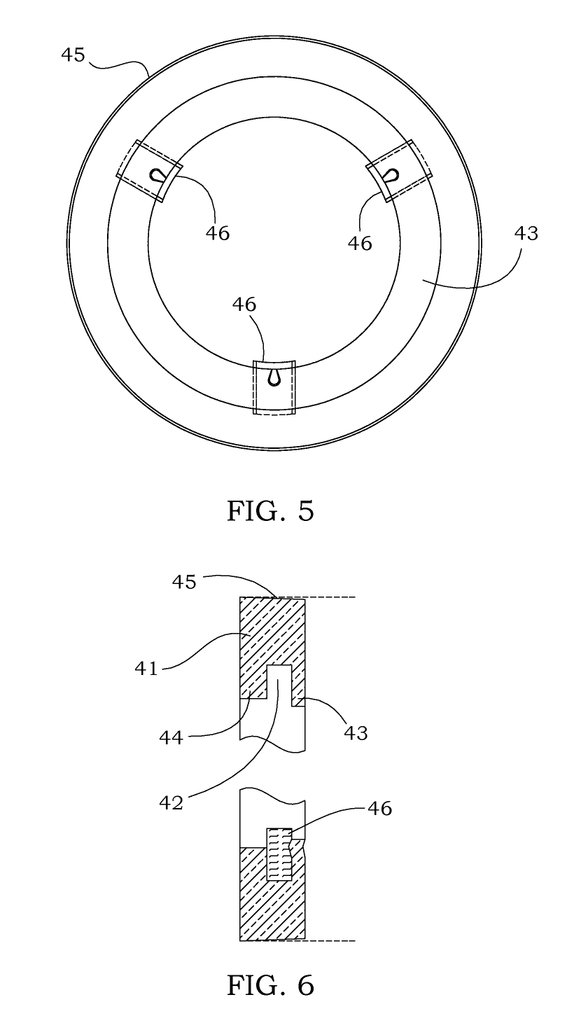

FIG. 5 is an axial view of the first embodiment of the current diverter ring.

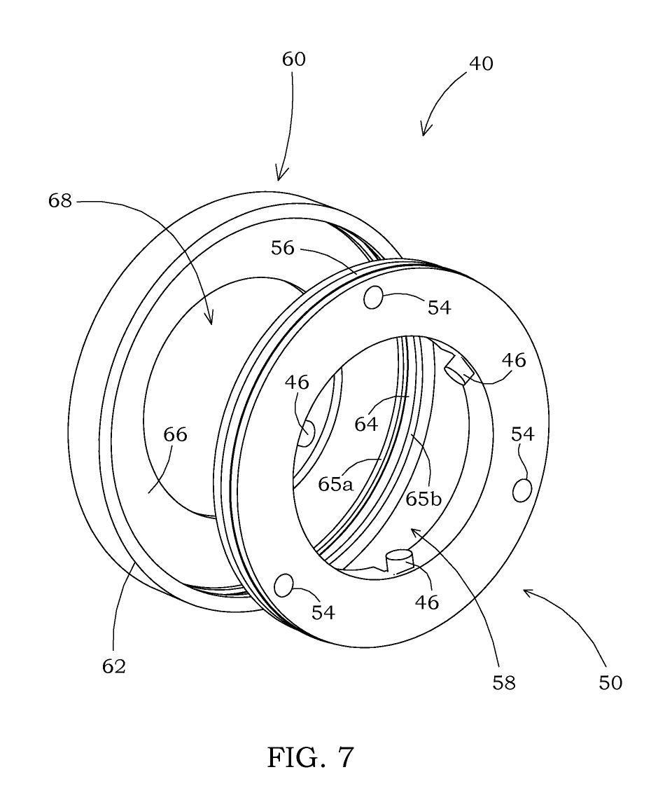

FIG. 6 is a cross-sectional view of the first embodiment of the current diverter ring.

FIG. 7 is a perspective, exploded view of a second embodiment of the current diverter ring.

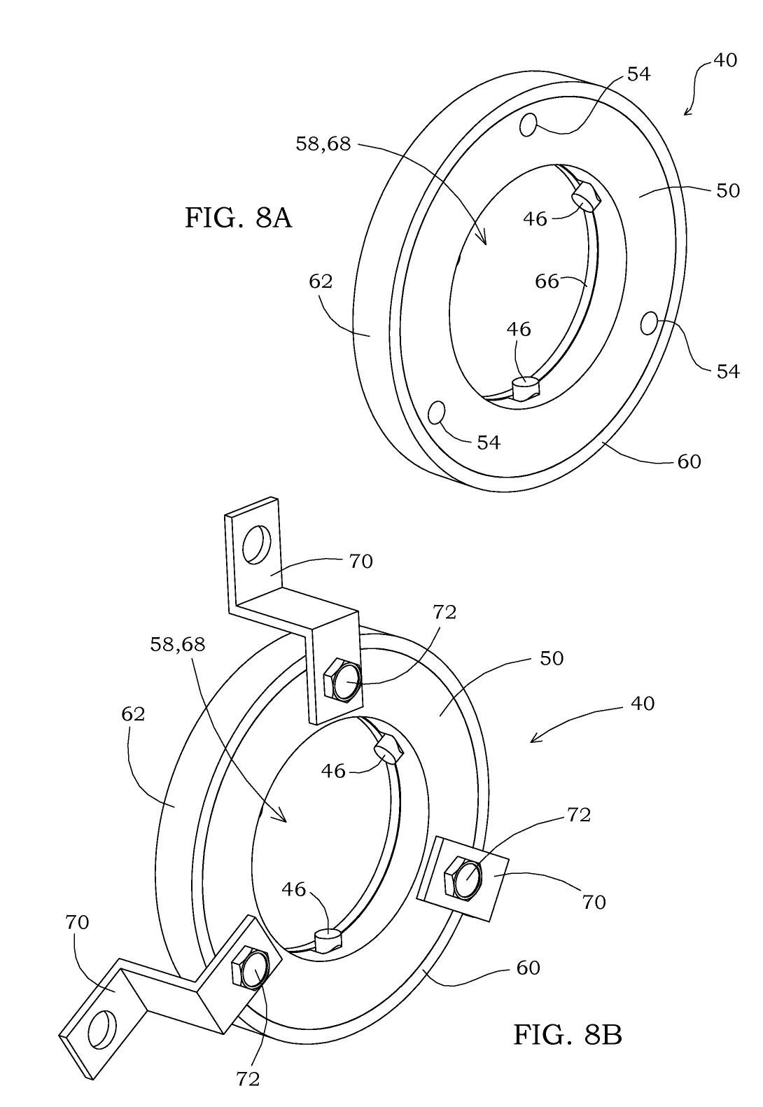

FIG. 8A is a perspective view of a second embodiment of the current diverter ring assembled.

FIG. 8B is a perspective view of a second embodiment of the current diverter ring assembled with mounting clips.

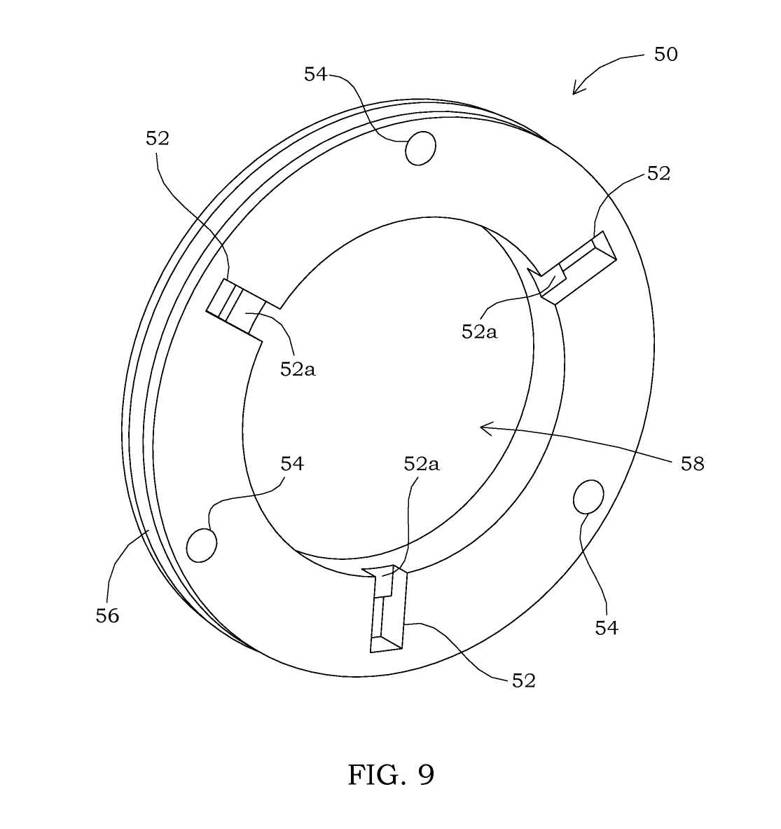

FIG. 9 is a detailed perspective view of one embodiment of an inner body for use with the second embodiment of the current diverter ring.

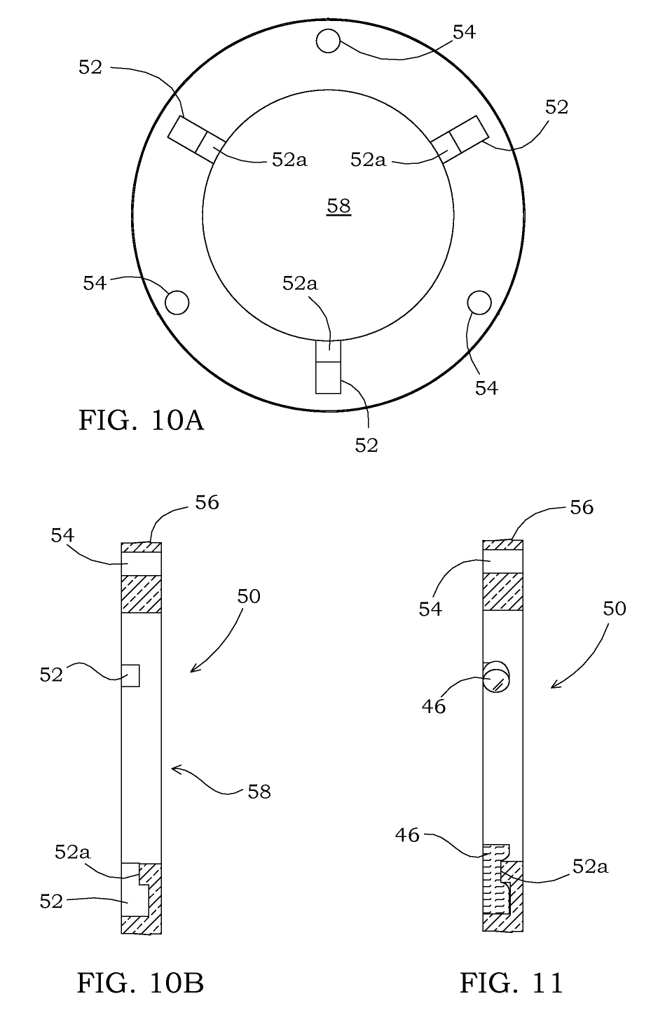

FIG. 10A is an axial view of one embodiment of an inner body for use with the second embodiment of the current diverter ring.

FIG. 10B is a cross-sectional view of one embodiment of an inner body for use with the second embodiment of the current diverter ring.

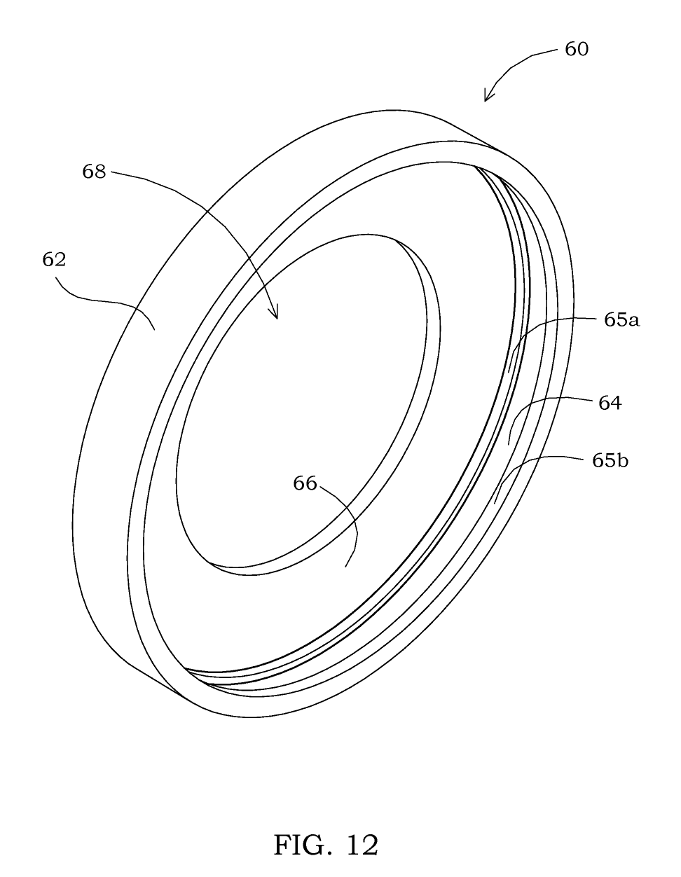

FIG. 11 is a cross-sectional view of one embodiment of an inner body for use with the second embodiment of the current diverter ring with conductive fibers positioned therein.

FIG. 12 is a detailed perspective view of one embodiment of an outer body for use with the second embodiment of the current diverter ring.

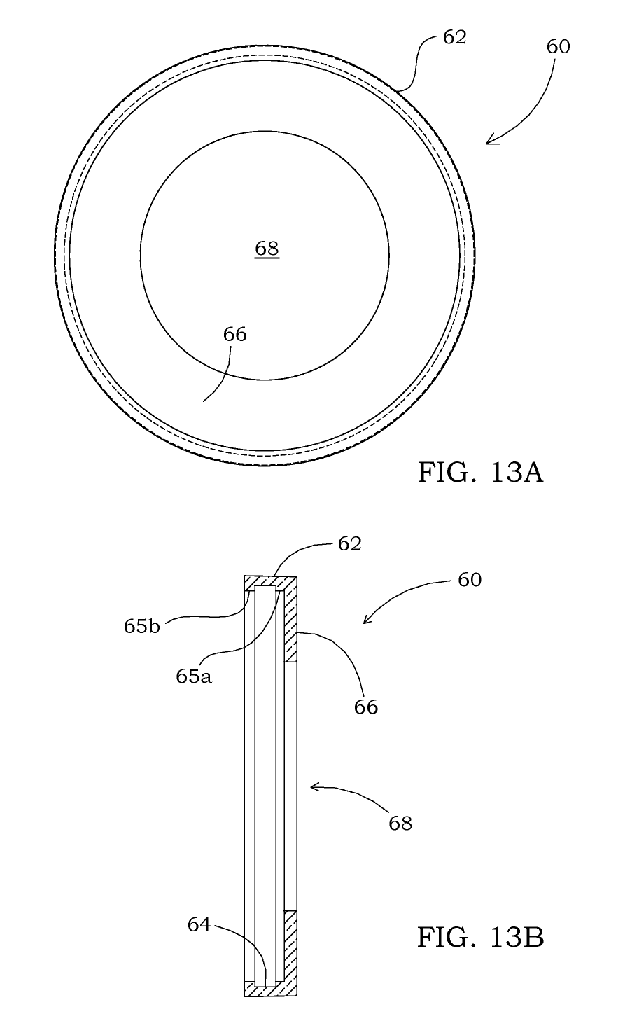

FIG. 13A is an axial view of one embodiment of an outer body for use with the second embodiment of the current diverter ring.

FIG. 13B is a cross-sectional view of one embodiment of an outer body for use with the second embodiment of the current diverter ring.

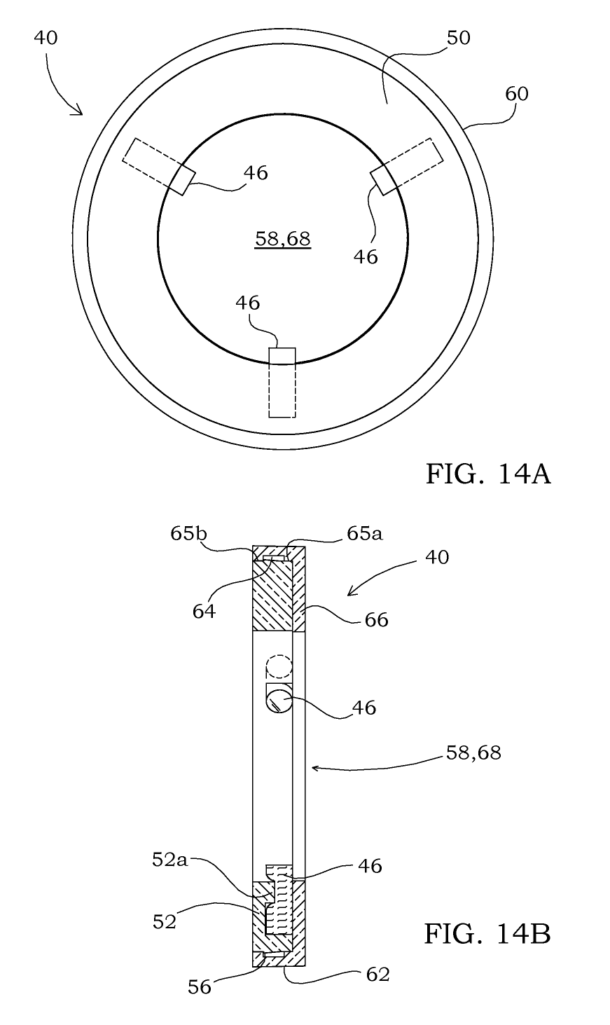

FIG. 14A is an axial view of the second embodiment of the current diverter ring assembled.

FIG. 14B is a cross-sectional view of the second embodiment of the current diverter ring assembled.

### DETAILED DESCRIPTION—ELEMENT LISTING

| Description | Element No. |
|---|---|
| Bearing isolator | 10 |
| Bearing | 12 |
| Shaft | 14 |
| Motor housing | 16 |
| Sealing member | 17 |
| O-ring | 18 |
| Stator | 20 |
| Stator main body | 22 |
| Stator radial exterior surface | 23 |
| Receptor groove | 24 |
| Conductive segment annular channel | 25 |
| Stator axial projection | 26 |
| Stator radial projection | 28 |
| Stator axial groove | 29 |
| Rotor | 30 |
| Rotor main body | 32 |
| Rotor axial exterior surface | 33 |
| First axial interface gap | 34a |
| First radial interface gap | 34b |
| Rotor axial projection | 36 |
| Rotor radial projection | 38 |
| Rotor axial groove | 39 |
| Current diverter ring ™ (CDR ®) | 40 |
| CDR body | 41 |
| Annular channel | 42 |
| First wall | 43 |
| Second wall | 44 |
| CDR radial exterior surface | 45 |
| Conductive segment | 46 |
| CDR main aperture | 48 |
| Inner body | 50 |
| Radial channel | 52 |
| Catch | 52a |
| Mounting aperture | 54 |
| Ridge (locking) | 56 |
| Inner body main aperture | 58 |
| Outer body | 60 |
| Base | 62 |
| Annular groove | 64 |
| First annular shoulder | 65a |
| Second annular shoulder | 65b |
| Radial projection | 66 |
| Outer body main aperture | 68 |
| Strap | 70 |
| Fastener | 72 |

### DETAILED DESCRIPTION

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description of the present invention, and do not alone indicate or imply that the device or element referred to must have a particular orientation. In addition, terms such as “first”, “second”, and “third” are used herein and in the appended claims for purposes of description and are not intended to indicate or imply relative importance or significance.

One embodiment of a motor housing 16 with which the CDR® 40 may be used is shown in FIG. 1. The CDR 40 may be press-fit into an aperture in the motor housing 16, or it may be secured to the exterior of the motor housing 16 using straps 70 and fasteners 72 as described in detail below and as shown in FIG. 1. The CDR 40 may also be secured to a motor housing 12 via other structures and/or methods, such as chemical adhesion, welding, rivets, or any other structure and/or method known to those skilled in the art. The CDR 40 may also be configured to be engaged with a bearing isolator 10, or integrally formed with a bearing isolator 10, as described in detail below.

FIG. 2 illustrates a perspective view of one embodiment of a bearing isolator 10 configured to discharge electrical impulses from the shaft 14 through the motor housing 16. The bearing isolator 10 as shown in FIG. 2 may be mounted to a rotatable shaft 10 on either one or both sides of the motor housing 16. The bearing isolator 10 may be flange-mounted, press-fit (as shown in FIG. 2), or attached to the motor housing 16 using any other method and/or structure known to those skilled in the art, as was described above for the CDR 40. In some embodiments, set screws (not shown) or other structures and/or methods may be used to mount either the stator 20 to the motor housing 16 or the rotor 30 to the shaft 14. In another embodiment not pictured herein, the shaft 14 is stationary and the motor housing 16 or other structure to which the bearing isolator 10 is mounted may rotate.

In another embodiment, the CDR 40 and/or bearing isolator 10 may be mounted such that either the CDR 40 and/or bearing isolator 10 are allowed to float in one or more directions. For example, in one embodiment a portion of the bearing isolator 10 is positioned in an enclosure. The enclosure is fashioned as two opposing plates with main apertures therein, through which main apertures the shaft passes 14. The interior of the enclosure is fashioned such that the bearing isolator 10 and/or CDR 40 is positioned within a pill-shaped recess on the interior of the enclosure. The contact points between the bearing isolator 10 and/or CDR and the enclosure may be formed with a low friction substance, such as Teflon® affixed thereto.

A more detailed cross-sectional view of one embodiment of a bearing isolator 10 with which the CDR 40 may be used is shown in FIG. 3. The bearing isolator 10 shown in FIGS. 2 and 3 includes a stator 20 and a rotor 30, and is commonly referred to as a labyrinth seal. Generally, labyrinth seals are well known to those skilled in the art and include those disclosed in U.S. Pat. Nos. 7,396,017, 7,090,403, 6,419,233, 6,234,489, 6,182,972, and 5,951,020, and U.S. Pat. App. Pub. No. 2007/0138748 among others, all of which are incorporated by reference herein in their entireties.

The stator 20 is generally comprised of a stator main body 22 and various axial and/or radial projections extending therefrom and/or various axial and/or radial grooves configured therein, which are described in more detail below. In the embodiment shown in FIGS. 2 and 3, the stator 20 is fixedly mounted in a motor housing 16 with an O-ring 18 forming a seal therebetween.

The rotor 30 is generally comprised of a rotor main body 32 and various axial and/or radial projections extending therefrom and/or various axial and/or radial grooves configured therein, which are described in more detail below. In the embodiment shown, one stator axial projection 26 cooperates with a rotor axial groove 39, and one rotor axial projection 36 cooperates with a stator axial groove 29 to form a labyrinth passage between the interior portion of the bearing isolator 10 and the external environment. The rotor 30 may be fixedly mounted to a shaft 14 and rotatable therewith. An O-ring 18 may be used to form a seal therebetween. A sealing member 17 may be positioned between the stator 20 and rotor 30 on an interior interface therebetween to aide in prevention of contaminants entering the interior of the bearing isolator 10 from the external environment while simultaneously aiding in retention of lubricants in the interior of the bearing isolator 10.

In the embodiment of the bearing isolator 10 shown in FIGS. 2 and 3, one stator radial projection 28 provides an exterior groove in the stator 20 for collection of contaminants. A first axial interface gap 34a may be formed between the radially exterior surface of a stator radial projection 28 and the radially interior surface of a rotor radial projection 38. A first radial interface gap 34b may be formed between the axially exterior surface of a stator axial projection 26 and the axially interior surface of a rotor axial groove 39. A rotor axial projection 36 formed with a rotor radial projection 38 may be configured to fit within a stator axial groove 29 to provide another axial interface gap between the stator 20 and the rotor 30.

In the embodiment of a bearing isolator 10 pictured herein, one rotor radial projection 38 (adjacent the rotor axial exterior surface 33) extends radially beyond the major diameter of the stator axial projection 26. This permits the rotor 30 to encompass the stator axial projection 26. As is fully described in U.S. Pat. No. 6,419,233, which is incorporated by reference herein in its entirety, this radial extension is a key design feature of the bearing isolator 10 shown herein. The axial orientation of the first axial interface gap 34a controls entrance of contaminants into the bearing isolator 10. Reduction or elimination of contaminants improves the longevity and performance of the bearing isolator 10, bearing 12, and conductive segment(s) 46. The opening of the first axial interface gap 34a faces rearward, toward the motor housing 16 and away from the contaminant stream. The contaminant or cooling stream will normally be directed along the axis of the shaft 14 and toward the motor housing 16.

To facilitate the discharge of electric energy on or adjacent the shaft 14, the bearing isolator 10 may include at least one conductive segment 46 positioned within the stator 20. The stator 20 may be configured with a conductive segment annular channel adjacent the bearing 12, in which conductive segment annular channel the conductive segment 46 may be positioned and secured such that the conductive segment is in contact with or very nearly in contact with the shaft 14. As electrical charges accumulate on the shaft 14, the conductive segment 46 serves to dissipate those charges through the bearing isolator 10 and to the motor housing 16. The specific size and configuration of the conductive segment annular channel will depend on the application of the bearing isolator 10 and the type and size of each conductive segment 46. Accordingly, the size and configuration of the conductive segment annular channel is in no way limiting.

In the embodiment pictured herein, the bearing isolator 10 is formed with a receptor groove 24. The receptor groove 24 may be fashioned on the inboard side of the bearing isolator 10 adjacent the shaft 14, as best shown in FIG. 3. Generally, the receptor groove 24 facilitates the placement of a CDR 40 within the bearing isolator 10. However, other structures may be positioned within the receptor groove 24 depending on the specific application of the bearing isolator 10.

As shown and described, the bearing isolator 10 as shown in FIGS. 2 and 3 includes a plurality of radial and axial interface passages between the stator 20 and the rotor 30 resulting from the cooperation of the stator projections and rotor projections. An infinite number of configurations and/or orientations of the various projections and grooves exist, and therefore the configuration and/or orientation of the various projections and grooves in the stator 20 and/or rotor 30 are in no way limiting. The bearing isolator 10 as disclosed herein may be used with any configuration stator 20 and/or rotor 30 wherein the stator 20 may be configured with a conductive segment annular channel for retaining at least one conductive segment 46 therein or a receptor groove 24 as described in detail below.

A first embodiment of a current diverter ring (CDR) 40 is shown in perspective in FIG. 4, and FIG. 5 provides an axial view thereof. The CDR 40 may be used with any rotating equipment that has a tendency to accumulate an electrical charge on a portion thereof, such as electrical motors, gearboxes, bearings, or any other such equipment. The first embodiment of the CDR 40 is designed to be positioned between a motor housing 16 and a shaft 14 protruding from the motor housing 16 and rotatable with respect thereto.

Generally, the CDR 40 is comprised of a CDR body 41, which is fixedly mounted to the motor housing 16. In the first embodiment, a first wall 43 and a second wall 44 extend from the CDR body 41 and define an annular channel 42. At least one conductive segment 46 is fixedly retained in the annular channel 42 so that the conductive segment 46 is in contact with or very nearly in contact with the shaft 14 so as to create a low impedance path from the shaft 14 to the motor housing 16.

A cross-sectional view of the exemplary embodiment of the CDR 40 is shown in FIG. 6. As shown in FIG. 6, the axial thickness of the first wall 43 is less than that of the second wall 44. In the first embodiment, the conductive segment 46 is retained within the annular channel 42 by first positioning the conductive segment 46 within the annular channel 42 and then deforming the first wall 43 to reduce the clearance between the distal ends of the first and second walls 43, 44. Deforming the first wall 43 in this manner retains the conductive segment 46 within the annular channel 42. Depending on the material used for constructing the conductive segment 46, the deformation of the first wall 43 may compress a portion of the conductive segment 46 to further secure the position of the conductive segment 46 with respect to the shaft 14.

A detailed view of the CDR radial exterior surface 45 is shown in FIG. 6. The CDR radial exterior surface 45 may be configured with a slight angle in the axial dimension so that the CDR 40 may be press-fit into the motor housing 16. In the first embodiment, the angle is one degree, but may be more or less in other embodiments not pictured herein. Also, in the first embodiment the first wall 43 is positioned adjacent the bearing 12 when the CDR 40 is installed in a motor housing 16. However, in other embodiments not shown herein, the second wall 44 may be positioned adjacent the bearing 12 when the CDR 40 is installed in a motor housing 16, in which case the angle of the CDR radial exterior surface 45 would be opposite of that shown in FIG. 6. The optimal dimensions/orientation of the CDR body 41, annular channel 42, first wall 43, second wall 44, and CDR radial exterior surface 45 will vary depending on the specific application of the CDR 40 and are therefore in no way limiting to the scope of the CDR 40.

In other embodiments of the CDR 40 described in detail below, the CDR 40 is mounted to the motor housing 16 using mounting apertures 54, straps 70, and fasteners 74 fashioned in either the CDR 40 or motor housing 16. The CDR 40 may be mounted to the motor housing 16 by any method using any structure known to those skilled in the art without departing from the spirit and scope of the CDR 40.

In the embodiment of the CDR 40 shown in FIGS. 4 and 5, three conductive segments 46 are positioned within the annular channel 42. The optimal number of conductive segments 46 and the size and/or shape of each conductive segment 46 will vary depending on the application of the CDR 40, and is therefore in no way limiting. The optimal total length of all conductive segments 46 and the total surface area of the conductive segments 46 that are in contact with the shaft 14 (or very nearly in contact therewith) will vary from one application to the next, and is therefore in no way limiting to the scope of the CDR 40 or of a bearing isolator 10 configured with conductive segments 46 (such as the bearing isolator shown in FIGS. 2 and 3).

In the embodiment shown in FIGS. 4-6, the CDR 40 may be sized to be engaged with a bearing isolator 10 having a receptor groove 24, such as the bearing isolator 40 shown in FIGS. 2 and 3. As described above, FIGS. 2 and 3 shown one embodiment of a bearing isolator 10 fashioned to engage a CDR 40. The receptor groove 24 may be formed as an annular recess in the stator 20 that is sized and shaped to accept a CDR 40 similar to the one shown in FIGS. 4-6. The CDR 40 may be press-fit into the receptor groove 24, or it may be affixed to the stator 20 by any other method or structure known to those skilled in the art that is operable to fixedly mount the CDR 40 to the stator 20, including but not limited to set screws, welding, etc. When the CDR 40 is properly engaged with the receptor groove 24 in the stator 20, the CDR radial exterior surface 45 abuts and contacts the interior surface of the receptor groove 24.

In any of the embodiments of the CDR 40 or bearing isolator 10 employing conductive segments 46, the conductive segment 46 may be constructed of carbon, which is conductive and naturally lubricious. In one embodiment, the conductive segment 46 is constructed of a carbon mesh manufactured by Chesterton and designated 477-1. In other embodiments the conductive segment 46 has no coating on the exterior of the carbon mesh. When mesh or woven materials are used to construct the conductive segments 46, often the surface of the conductive segment 46 that contacts the shaft 14 becomes frayed or uneven, which may be a desirable quality to reduce rotational friction in certain applications. Shortly after the shaft 14 has been rotating with respect to the conductive segments 46, certain embodiments of the conductive segments 46 will wear and abrade from the surface of the shaft 14 so that friction between the conductive segments 46 and the shaft 14 is minimized. A microscopic gap between the conductive segments 46 and the shaft 14 may occur during steady-state operation, with only incidental contact between the conductive segments 46 and the shaft 14 occurring. The conductive segments 46 may be fibrous or solid material.

In general, it is desirable to ensure that the impedance from the shaft 14 to the motor housing 16 is in the range of 0.2 to 10 ohms to ensure that electrical charges that have accumulated on the shaft 14 are discharged through the motor housing 16 and to the base of the motor (not shown) rather than through the bearing(s) 12. The impedance from the shaft 14 to the motor housing 16 may be decreased by ensuring the fit between the bearing isolator 10 and motor housing 16, bearing isolator 10 and CDR 40, and/or CDR 40 and motor housing 16 has a very small tolerance. Accordingly, the smaller the gap between the bearing isolator 10 and motor housing 16, bearing isolator 10 and CDR 40, and/or CDR 40 and motor housing 16, the lower the impedance from the shaft 14 to the motor housing 16.

In other embodiments not pictured herein, conductive filaments (not shown) may be affixed to either the CDR 40 or bearing isolator 10 or embedded in conductive segments 46 affixed to either the CDR 40 or bearing isolator 10. Such filaments may be constructed of aluminum, copper, gold, carbon, conductive polymers, conductive elastomers, or any other conductive material possessing the proper conductivity for the specific application. Any material that is sufficiently lubricious and with sufficiently low impedance may be used for the conductive segment(s) 46 in the CDR 40 and/or bearing isolator 10.

In another embodiment of the CDR 40 not pictured herein, the CDR 40 is affixed to the shaft 14 and rotates therewith. The first and second walls 43, 44 of the CDR 40 extend from the shaft 14, and the CDR main body 41 is adjacent the shaft 14. The centrifugal force of the rotation of the shaft 14 causes the conductive segments 46 and/or conductive filaments to expand radially as the shaft 14 rotates. This expansion allows the conductive segments 46 and/or filaments to make contact with the motor housing 16 even if grease or other contaminants and/or lubricants (which increase impedance and therefore decrease the ability of the CDR 40 to dissipate electrical charges from the shaft 14 to the motor housing 16) have collected in an area between the CDR 40 and the motor housing 16.

In another embodiment not pictured herein, a conductive sleeve (not shown) may be positioned on the shaft 14. This embodiment is especially useful for a shaft 14 having a worn or uneven surface that would otherwise lead to excessive wear of the conductive segments 46. The conductive sleeve (not shown) may be constructed of any electrically conductive material that is suitable for the particular application, and the conductive sleeve (not shown) may also be fashioned with a smooth radial exterior surface. The conductive sleeve (not shown) would then serve to conductive electrical charges from the shaft 14 to the conductive segments 46 in either the CDR 40 or a bearing isolator 10. Another embodiment that may be especially useful for use with shafts 14 having worn or uneven exterior surfaces is an embodiment wherein conductive filaments or wires are inserted into the conductive segments 46. These conductive filaments or wires may be sacrificial and fill in depressions or other asperities of the surface of the shaft 14.

In another embodiment not pictured herein, conductive screws (not shown) made of suitable conductive materials may be inserted into the conductive segments 46. Furthermore, spring-loaded solid conductive cylinders may be positioned within the CDR 40 and/or bearing isolator 10 in the radial direction so as to contact the radial exterior surface of the shaft 14.

A second embodiment of a CDR 40 is shown in FIGS. 7-14. In the second embodiment of the CDR 40, the CDR is formed from the engagement of an inner body 50 with an outer body 60, which are shown disengaged but in relation to one another in FIG. 7. The inner body 50 and outer body 60 in the second embodiment of the CDR 40 engage one another in a snapping, interference-type fit, which is described in detail below.

A perspective view of an inner body 50, which may be generally ring shaped, is shown in FIG. 9. The inner body 50 may include at least one radial channel 52 fashioned in an exterior face of the inner body 50, which includes a main aperture 58 through which a shaft 14 may be positioned. The embodiment pictured in FIG. 9 includes three radial channels 52, but other embodiments may have a greater or lesser number of radial channels 52, and therefore the number of radial channels in no way limits the scope of the CDR 40. Each radial channel 52 may be formed with a catch 52a therein to more adequately secure certain types of conductive segments 46. It is contemplated that a catch 52a will be most advantageous with conductive segments 46 made of a deformable or semi-deformable material (as depicted in FIG. 14B), but a catch 52a may be used with conductive segments 46 constructed of materials having different mechanical properties. The radial channels 52 as shown are configured to open toward a shaft 14 positioned in the main aperture 58. The inner body 50 may be formed with a ridge 56 on the radial exterior surface thereof. The ridge 56 may be configured to engage the annular groove 64 formed in the outer body 60 as described in detail below.

The inner body 50 may be formed with one or more mounting apertures 54 therein. The embodiment shown in FIGS. 8-11 is formed with three mounting apertures 54. Mounting apertures 54 may be used to secure the CDR 40 to a motor housing 16 or other structure as shown in FIG. 1. A strap 70 or clip may be secured to the CDR 40 using a fastener 72, such as a screw or rivet, engaged with a mounting aperture 54, as shown in FIGS. 1 and 8B. The presence or absence of mounting apertures 54 will largely depend on the mounting method of the CDR 40. For example, in the embodiment shown in FIGS. 14A and 14B, the inner body 50 does not include any mounting apertures 54. It is contemplated that such embodiments will be optimal for use within a bearing isolator 10 and/or a CDR 40 that will be press fit into a motor housing 16 or other structure.

A perspective view of an outer body 60, which also may be generally ring shaped, is shown in FIG. 12. The outer body 60 may be formed with a base 62 having an annular groove 64 formed on the radial interior surface thereof. The annular groove 64 may be defined by a first annular shoulder 64a and a second annular shoulder 65b. A radial projection 66 may extend radially inward from the base 62 adjacent either the first and/or second shoulder 65a, 65b. In the embodiment picture, the radial projection 66 is positioned adjacent the first annular shoulder 65a and includes a main aperture 68 therein, through which a shaft 14 may be positioned. The annular groove 64 may be configured such that the ridge 56 formed in the inner body 50 engages the annular groove 64 so as to substantially fix the axial position of the inner body 50 with respect to the outer body 60. As shown in FIGS. 10B, and 14B, the ridge 56 may be slanted or tapered so that upon forced insertion of the inner body 50 in the outer body 60, the ridge 56 slides past the second annular shoulder 65b and into the annular groove 64 to axially secure the inner body 50 and the outer body 60. The engagement between the ridge 56 and the annular groove 64 thereafter resists separation or dissociation of the inner and outer bodies 50, 60. In other embodiments not shown herein, the ridge 56 is not limited to a tapered configuration. The ridge 56 and base 62 may also be configured so an interference fit is created upon engagement to resist separation or disassociation of the inner and outer bodies 50, 60.

As shown in FIGS. 14A and 14B, the inner body 50 and outer body 60 may be configured so that the interior periphery of the radial projection 66 has the same diameter as the interior periphery of the inner body 50 so that both the inner and outer bodies 50, 60 have the same clearance from a shaft 14 when installed. It is contemplated that in most applications the CDR 40 will be installed so that the surface shown in FIG. 14A is axially exterior to the motor housing 16 or other structure. However, if the CDR 40 is engaged with a bearing isolator 10, the CDR 40 may be oriented such that the surface shown in FIG. 14A is facing toward the interior of the motor housing 16 or other structure to which the bearing isolator 10 is mounted.

As shown in FIG. 11, conductive segments 46 may be positioned in the radial channel 52. It is contemplated that the radial channels 52 will be fashioned in the axial surface of the inner body 50 that is positioned adjacent the radial projection 66 of the outer body 60 when the CDR 40 is assembled, as shown in FIGS. 14A and 14B. This orientation secures the axial position of the conductive segments 46. Typically, but depending on the materials of construction, the conductive segments 46 are sized so as to extend past the inner wall of the inner body 50 into the main aperture 58 to contact the shaft 14. The radial channels 52 are sized so as to not intersect the outer periphery of the inner body 50. This prevents the conductive segment 46 from contacting the annular groove 64 of the outer body 60.

The bearing isolator 10 and CDR 40 may be constructed from any machinable metal, such as stainless steel, bronze, aluminum, gold, copper, and combinations thereof, or other material having low impedance. The CDR 40 or bearing isolator 10 may be flange-mounted, press-fit, or attached to the motor housing 16 by any other structure or method, such as through a plurality of straps 70 and fasteners 72.

In certain applications, performance of the bearing isolator 10 may be improved by eliminating the O-rings 18 and their companion grooves fashioned in the stator 20 and the rotor 30, as shown in FIGS. 2 and 3. The high-impedance nature of material used to construct the O-ring 18 (such as rubber and/or silicon) may impede conductivity between bearing isolator 10 and the motor housing 16, thereby decreasing the overall electrical charge dissipation performance of the bearing isolator 10. However, if the O-rings 18 may be constructed of a low-impedance material, they may be included in any application of the CDR 40 and/or bearing isolator 10. The optimal dimensions/orientation of the CDR 40, inner body 50, outer body 60, and various features thereof will vary depending on the specific application of the CDR 40 and are therefore in no way limiting to the scope of the CDR 40.

The bearing isolator 10 and/or CDR 40 employed with a motor housing 16 creates a stable, concentric system with the rotating shaft 14 as the center point. Inserting a CDR 40 into bearing isolator such as the one shown in FIGS. 2 and 3 within the motor housing 16 forms a relatively fixed and stable spatial relationship between the conducting elements, thereby improving the collection and conduction of electrostatic discharge from the shaft 14 to ground, through the conducting elements of the CDR 40 and bearing isolator 10. This improved motor ground sealing system directly seats major elements together, which compensates for imperfections in the shaft 14 (which may not be perfectly round) and ensures the variation or change in distance from the conductive segments 46 to the surface of the shaft 14 caused by external forces acting on the CDR 40 and/or bearing isolator 10 are minimal. This promotes effective ionization of the air surrounding the conductive segments 46 and conduction of electrical charges from the shaft 14 to the motor housing 16.

Having described the preferred embodiment, other features of the CDR 40 and disclosed bearing isolators 10 will undoubtedly occur to those versed in the art, as will numerous modifications and alterations in the embodiments as illustrated herein, all of which may be achieved without departing from the spirit and scope of the CDR 40 and/or bearing isolator 10. It should be noted that the bearing isolator 10 and CDR 40 are not limited to the specific embodiments pictured and described herein, but are intended to apply to all similar apparatuses and methods for dissipating an electrical charge from a shaft 14 to a motor housing 16. Modifications and alterations from the described embodiments will occur to those skilled in the art without departure from the spirit and scope of the bearing isolator 10 and CDR 40.

1. A current diverter ring comprising:
a. a body, wherein said body is formed substantially as a ring;
b. an annular channel, wherein said annular channel is formed on the radial-interior surface of said body;
c. a first wall extending from said body, wherein said first wall defines a first axial limit of said annular channel;
d. a second wall extending from said body, wherein said second wall defines a second axial limit of said annular channel; and
e. at least one conductive segment, wherein each conductive segment is positioned within said annular channel.

2. The current diverter ring according to claim 1 wherein said body is fixedly mounted to a motor housing, and wherein said annular channel is further defined as facing a shaft protruding from said motor housing.

3. The current diverter ring according to claim 1 wherein said body is fixedly mounted to a shaft protruding from a motor housing, and wherein said annular channel is further defined as facing said motor housing.

4. The current diverter ring according to claim 1 wherein said body is fixedly mounted to a receptor groove fashioned in a stator of a bearing isolator.

5. A current diverter ring comprising:
a. an inner body, said inner body comprising:
i. a main aperture;
ii. a radial channel fashioned in one face of said inner body;
iii. a ridge fashioned on the exterior radial surface of said main body;
b. an outer body, said outer body comprising:
i. a base;
ii. an annular groove fashioned in the radial interior surface of said base, wherein said annular groove is defined by a first annular shoulder and a second annular shoulder;
iii. a radial projection, wherein said radial projection extends radially inward from said base, wherein a main aperture is formed in said radial projection, and wherein said outer body and said inner body are configured such that the engagement of said ridge with said annular groove secures said inner body to said outer body in the axial direction; and
c. a conductive segment, wherein said conductive segment is positioned in said radial channel.

6. The current diverter ring according to claim 5 wherein said inner body further comprises a plurality of radial channels, and wherein said current diverter ring further comprises a plurality of conductive segments.

7. The current diverter ring according to claim 6 wherein said current diverter ring is further defined as having said plurality of radial channels in said inner body positioned adjacent said radial projection in said outer body.

8. The current diverter ring according to claim 7 wherein said ridge is further defined as being angled in the axial direction.

9. The current diverter ring according to claim 8 wherein the radial exterior surface of said base is further defined as being angled in the axial direction such that said current diverter ring may be securely pressed into a receptor groove in a bearing isolator or an aperture formed in a motor housing.

10. The current diverter ring according to claim 8 wherein said inner body further comprises a plurality of mounting apertures positioned in the face thereof opposite said plurality of radial channels, and wherein a plurality of fasteners and straps are used to secure said current diverter ring to a motor housing.

11. The current diverter ring according to claim 8 wherein said conductive segment is further defined as a carbon-based filament.

12. The current diverter ring according to claim 8 wherein said plurality of radial channels is further defined as having a catch positioned therein.

13. The current diverter ring according to claim 8 wherein said radial projection of said outer body is further defined as being configured so that the inside diameter of said inner body is substantially equal to the inside diameter of said radial projection.

14. The current diverter ring according to claim 8 wherein each conductive segment in said plurality of conductive segments is further defined as being a fibrous, carbon-based material.

15. The current diverter ring according to claim 8 wherein said inner body and said outer body are further defined as being constructed of bronze.

16. A bearing isolator comprising:
a. a stator, said stator comprising:
i. a main body;
ii. a plurality of projections extending both axially and radially beyond said main body;
iii. a receptor groove, said receptor groove positioned adjacent a shaft;
b. a rotor, said rotor fixedly mounted to said shaft, said rotor comprising:
i. a main body;
ii. a plurality of projections extending both radially and axially beyond said main body, wherein said plurality of projections of said rotor intermesh with said plurality of projections of said stator to form a labyrinth seal;
c. a current diverter ring, said current diverter ring comprising:
i. a body, wherein said body is formed substantially as a ring, and wherein said body is fixedly mounted within said receptor groove;
ii. an annular channel, wherein said annular channel is formed on the radial-interior surface of said body;
iii. a first wall extending from said body, wherein said first wall defines a first axial limit of said annular channel;
iv. a second wall extending from said body, wherein said second wall defines a second axial limit of said annular channel; and
v. at least one conductive segment, wherein each conductive segment is positioned within said annular channel.

17. The bearing isolator according to claim 16 wherein at least one radial projection of said plurality of projections extending from said rotor extends beyond all radial projections of said plurality of projections extending from said stator.

18. A method of dissipating an electrical charge from a shaft through a motor housing comprising:
a. fixing a current diverter ring to said motor housing;
b. mounting at least one conductive segment within said current diverter ring, wherein said at least one conductive segment is in close proximity to or in contact with said shaft;
c. transmitting said electrical charge from said shaft to said at least one conductive segment;
d. transmitting said electrical charge from said at least one conductive segment to said current diverter ring; and
e. transmitting said electrical charge from said current diverter ring to said motor housing.

19. A method of dissipating an electrical charge from a shaft through a motor housing comprising:
a. fixing a bearing isolator to said motor housing;
b. mounting at least one conductive segment within said bearing isolator, wherein said at least one conductive segment is in close proximity to or in contact with said shaft;
c. transmitting said electrical charge from said shaft to said at least one conductive segment;
d. transmitting said electrical charge from said at least one conductive segment to said bearing isolator; and
e. transmitting said electrical charge from said bearing isolator to said motor housing.

20. A method of dissipating an electrical charge from a shaft through a motor housing comprising:
a. fixing a current diverter ring to a bearing isolator;
b. fixing said bearing isolator to said motor housing;
c. mounting at least one conductive segment within said current diverter ring, wherein said at least one conductive segment is in close proximity to or in contact with said shaft;
d. transmitting said electrical charge from said shaft to said at least one conductive segment;
e. transmitting said electrical charge from said at least one conductive segment to said current diverter ring;
f. transmitting said electrical charge from said current diverter ring to said bearing isolator; and
g. transmitting said electrical charge from said bearing isolator to said motor housing.
